(19) United States
(12) Patent Application Publication
(10) Pub. No.: US 2019/0391564 A1
(43) Pub. Date: Dec. 26, 2019

(54) METHOD FOR IDENTIFYING A 3D ELEMENT, PARTICULARLY AN ELEMENT USED TO PRODUCE A COMPLEX PRODUCT COMPRISING SAID ELEMENT

(71) Applicant: SAINT-GOBAIN PERFORMANCE PLASTICS FRANCE, Charny Oree De Puisaye (FR)

(72) Inventors: Pierre CONZE, Toulouse (FR); Jerome BRAVARD, Cruscades (FR)

(73) Assignee: SAINT-GOBAIN PERFORMANCE PLASTICS FRANCE, Charny Oree De Puisaye (FR)

(21) Appl. No.: 16/482,131

(22) PCT Filed: Feb. 13, 2018
(86) PCT No.: PCT/EP2018/053563

§ 371 Date: Jul. 30, 2019

(30) Foreign Application Priority Data
Feb. 13, 2017 (FR) 1770133

(51) Int. Cl. G05B 19/4099; G06K 19/06

(52) U.S. Cl. CPC G05B 19/4099; G05B 2219/49023; G06K 19/06037

(57) ABSTRACT

A method is for identifying a 3D element by a 2D or 3D marking, particularly a QR code. The element is used alone or integrated into a complex product. The method includes manufacturing the 3D element without shaping; producing, during the manufacturing, the initial 2D or 3D marking element with an initial deformation DI; shaping the element; and simultaneous shaping of the initial marking into final marking, which can be read by a flat marking reader. Also described is the element obtained by the method and the complex product integrating at least one element.

The present invention is a method for identifying a 3D element, particularly an element used to produce a complex product comprising at least said element. The invention also relates to the element obtained by the method and to the complex product obtained from at least said element.

Hereinafter in the continuation of the description, but in a non-limiting manner, “element” means a 3D armature, which can be used alone, or which in particular is designed to be used in the manufacture of a complex product. An armature is for example a 3D technical part produced by weaving, or a 3D technical part obtained by knitting, in general with a geometry which cannot be developed.

Hereinafter in the continuation of the description, but in a non-limiting manner, “complex product” means a composite material integrating at least said armature, by gluing or by embedding in a resin matrix.

The complex products must be identified, but it is often necessary to identify in advance each element which is necessary for the production of a complex product.

Thus, identifiers exist of the RFID label type, which can be read by readers working on radio waves, which readers are able to interrogate said labels, which in turn respond according to the more or less complex programming provided on said label.

It is difficult to integrate a label of this type in a resin matrix for example, if the example selected is applied, and the interrogation becomes more difficult, or even impossible.

Furthermore, this type of identification system is preferably applied to reading of a large number of products in passage, but a reading and encoding installation which is not simple is required.

Labels of the barcode type also exist, which are now relatively obsolete, comprising combinations of parallel bars with different widths and spacings, as a replacement for alphanumerical codes.

QR codes, which are more recent, are more attractive because of the large amount of information they contain with 2D encoding, and with simple optical reading of the dark or light areas.

These QR codes can be read by flat code readers which are simple and can be integrated, for example, in the camera of a smartphone associated with appropriate software.

As a result of this fact, these QR codes have had a certain amount of success.

Codes of this type are thus placed on flat surfaces of products with which it is wished to associate information.

QR code readers permit readings within a given solid angle. Outside this angle, the code is too deformed to be read. In all cases, the deformation for the reader is homogenous over the entire surface, since the surface is flat.

However, there are elements which do not have any flat surface, such that it is impossible to print a QR code in the habitual manner.

What is even more complex is that the element is often manufactured flat, but is designed to be shaped at a given moment.

Although the method for identification by means of a QR code is very attractive, it cannot be applied to these 3D parts, since it is no longer possible to read said QR code after the element has been shaped, in the case of a composite material in particular, where the element is integrated in a matrix.

In addition, the QR code must continue to be visible once the marked element is integrated in the complex product. In the case of a composite material, the resin must remain transparent to visible light.

The present invention relates to a method for 2D or 3D marking of a flat element, which can be read with a simple flat code reader, after shaping and/or integration in a complex product, said element being deformed after marking.

Thus, the method according to the invention for identifying a 3D element by means of a 2D or 3D marking, particularly a QR code, said element being used alone or integrated into a complex product, is characterized in that it comprises the following succession of steps:
manufacture of the 3D element without shaping;
production, during the manufacture, of the initial 2D or 3D marking element with an initial deformation DI;
shaping of said element;
simultaneous shaping of the initial marking into final marking, which can be read by a flat marking reader.

The method according to the present invention is now described with reference to the appended drawings, in which the different figures represent:

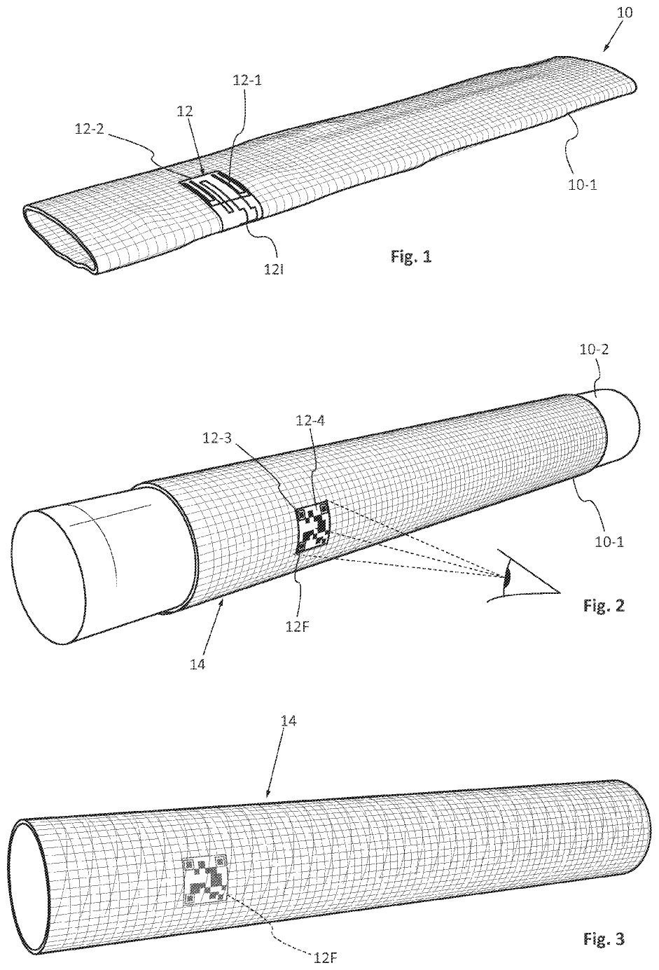

FIG. 1 is a view of an element provided with marking produced flat;

FIG. 2 is a view of the element in FIG. 1 after shaping;

FIG. 3 is a view of the element integrated into a complex product.

FIG. 1 shows an element 10, which in this embodiment is a sleeve 10-1, obtained by knitting, from two threads which are of different colors, or at least permit a contrast. The sleeve 10-1 taken in the example has a simple cylindrical form.

The knitting is carried out in a known manner, in order to obtain a sleeve 10-1 which has a substantially flat shape when the knitting is completed, i.e. a flattened cylinder.

This flattened cylinder can be shaped on a template 10-2 with a cylindrical shape, with the number of meshes compensating for the differentials of deformation, when these exist on complex shapes. The element 10 of the sleeve type 10-1, when the knitting is completed, is represented in FIG. 1.

During the knitting, the initial 2D or 3D marking 12I is carried out by the meshes themselves, showing on the outer surface of said sleeve 10-1; the light thread in the areas 12-1 must be light, and the dark thread in the areas 12-2 must be dark. The embodiment in FIG. 1 is obtained, with initial marking in the form of a rectangle or a diabolo, according to the deformations envisaged, which are simple in the case of a cylinder.

The pattern of the marking 12 to be obtained once the sleeve has been shaped, in the embodiment selected, is a 2D QR code with a square 12-3 comprising a matrix of patterns, in this case squares 12-4 with smaller dimensions, with a specific alternation of light patterns and dark patterns, in this case small light squares and small dark squares.

The final marking 12F to be obtained is thus that which is represented in FIG. 2, i.e. a square starting from a rectangle or a diabolo, according to the deformations.

In order to obtain final marking 12F which is identical to that of FIG. 2, the method consists of carrying out the initial marking 12I during the manufacture of the element 10, in this case the sleeve 10-1, with an initial deformation DI as shown in FIG. 1 in the case of an element 10 of the cylindrical sleeve type 10-1.

The initial marking 12I corresponds to the final marking 12F provided with correction of deformation for compensation of the deformation of the element between the shape when the manufacture is completed and the shape once the element has been shaped, in this case on the template 10-2.

Once the element 10 has assumed its real final shape, in this case the cylindrical shape, a final marking 12F is obtained which can be read directly by a QR code reader designed for flat markings.

The final marking 12F can then be read within a given solid angle.

Thus, the element can be identified when it is shaped.

When the element 10 is used for example for the manufacture of a complex product, in the particular embodiment selected, i.e. a part 14 made of composite materials, the element 10 is shaped on a template, and the assembly is introduced into a mold, not represented, such as to inject resin 16 which will embed said element in shape, and fix it in this shape. The resin can comprise a composition of a plurality of resins, and draping can complete the element.

In this case, in FIG. 3, the sleeve 10-1 is integrated in a resin matrix 16.

This resin 16 is transparent in the case selected, and the final marking 12F, i.e. the QR code, can be read in natural light with a simple reader, and used for reading of the flat markings.

According to a variant of the present invention, it is possible to provide two threads which have light/dark contrasts on a particular wavelength, such as a wavelength in the ultraviolet spectrum.

In this case, the reader must be adapted, but the advantage is not to make the marking visible in natural light.

Marking of this type can be very useful for combating counterfeiting of technical parts for example, or luxury products.

The example which has just been described can be transposed fully to fabric in which the threads are woven with contrasts over at least a part, with initial deformation of the marking making it possible to compensate for the deformation during the shaping of said fabric, in order to permit the reading of the identifier, in this case a QR code.

In the case of a complex shape, it is also possible to provide more complex deformation during the generation of the code, taking into account the deformations in the three directions.

1. A method for identifying a 3D element by a 2D or 3D marking, said element being used alone or integrated into a complex product, the method comprising the following succession of steps:
manufacturing the 3D element without shaping;
producing, during the manufacturing said element, the initial 2D or 3D marking with an initial deformation DI;
shaping said element; and
simultaneous shaping of the initial marking into a final marking, which is configured to be read by a flat marking reader.

2. The method for identifying a 3D element as claimed in claim 1, wherein the marking added is a 2D or 3D QR code.

3. The method for identifying a 3D element as claimed in claim 1, wherein the marking comprises a matrix of light patterns and dark patterns.

4. The method for identifying a 3D element as claimed in claim 1, wherein the element is produced by knitting, and the initial marking is integrated during the knitting.

5. The method for identifying a 3D element as claimed in claim 1, wherein the element is produced by weaving, and the initial marking is integrated during the weaving.

6. The method for identifying a 3D element as claimed in claim 1, wherein the marking is carried out by two threads with light/dark contrasts in a wavelength in the ultraviolet spectrum.

7. An element obtained by the method as claimed in claim 1, wherein the marking is integrated in the element.

8. A complex product obtained by integration of at least one element obtained by the method as claimed in claim 1, the complex product comprising a composite material integrating the at least one element by gluing or by integration in a resin matrix.
